(19) United States
(12) Patent Application Publication
(10) Pub. No.: US 2013/0036076 A1
(43) Pub. Date: Feb. 7, 2013

(54) METHOD FOR KEYWORD EXTRACTION

(71) Applicants: Sheng-Wen Yang, Beijing (CN); Yuhong Xiong, Beijing (CN); Wei Liu, Beijing (CN)

(72) Inventors: Sheng-Wen Yang, Beijing (CN); Yuhong Xiong, Beijing (CN); Wei Liu, Beijing (CN)

(73) Assignee: HEWLETT-PACKARD DEVELOPMENT COMPANY, L.P., Houston, TX (US)

(21) Appl. No.: 13/641,054

(22) PCT Filed: Apr. 14, 2010
(86) PCT No.: PCT/CN2010/071758

§ 371 Date: Oct. 12, 2012

(51) Int. Cl. G06F 17/30; G06F 15/18

(52) U.S. Cl. 706/12; 707/755; 707/E17.009

(57) ABSTRACT

Presented is a method of extracting keywords. The method includes obtaining a corpus of documents, determining a first set of words that appear as keywords in a document present in the corpus of documents, determining a second set of words that appear in the corpus of documents but not necessarily appear as keywords in the document, and determining a final set of keywords for the document by combining the first set of words with the second set of words.

### BACKGROUND

With the advent of computers and the internet, the world has seen an information explosion like never before. Gone are the days, when print used to dominate the medium of expression. The internet has changed the way, people consume data. It's very common to find a digital version of almost every other document that is printed today. Such massive digitization, although immensely beneficial in many ways, has its own limitations. There is always this pressing problem of finding the right information or data. Therefore, document search remains one of the most challenging areas of research.

Keywords or keywords offer a valuable mechanism for characterizing text documents. They offer a meaningful way of searching for information in a document or corpus of documents. Traditionally, keywords are manually specified by authors, librarians, professional indexers and catalogers. However, with thousands of documents getting digitized everyday, manual specification is no longer possible. Computer-based automatic keyword extraction was a natural corollary of this problem. A number of keyword extraction methods have been proposed in the past several years. In some methods, the problem is formulated as a supervised classification problem and a classifier is trained based on a labeled training dataset. In some other methods, the keyword extraction is formulated as a ranking problem and candidate words are ranked according to some measures. The existing methods, however, have their own limitations. For example, they don't explicitly consider the semantic relationship between the candidate keywords and the document. Also, the extracted keywords are limited to the document content.

### BRIEF DESCRIPTION OF THE DRAWINGS

For a better understanding of the invention, embodiments will now be described, purely by way of example, with reference to the accompanying drawings, in which:

FIG. 1 shows a flow chart of a computer-implemented method of keyword extraction according to an embodiment

FIG. 2 shows a flowchart of a subroutine of the method of FIG. 1 according to an embodiment.

FIG. 3 shows a flowchart of another subroutine of the method of FIG. 1 according to an embodiment.

FIG. 4. shows a block diagram of a computer system 400 upon which an embodiment may be implemented.

### DETAILED DESCRIPTION OF THE INVENTION

The following terms are used interchangeably through out the document including the accompanying drawings.

(a) “keyword” and “key phrase”

(b) “document” and “electronic document”

Embodiments of the present invention provide methods, computer executable code and computer storage medium for extracting keywords from a document which may be present in a corpus of documents. Specifically, the disclosed methods involve an in-document keyword extraction method and an in-corpus keyword extraction method. The former extracts keywords that appear in a single document; the latter extracts keywords that appear in a corpus (may not appear in the document).

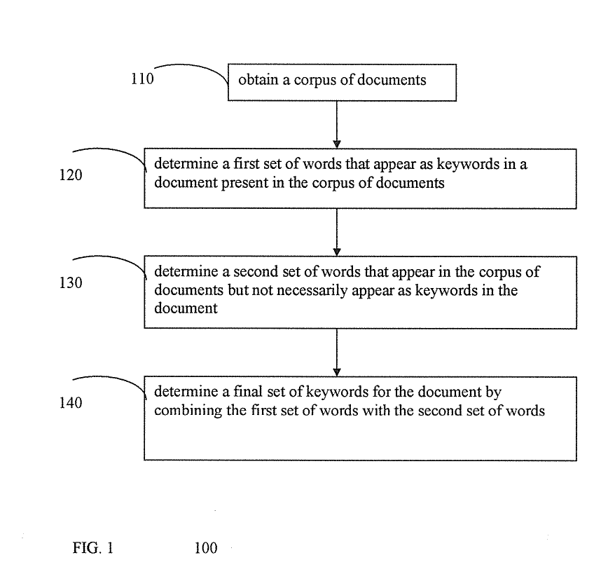

FIG. 1 shows a flow chart of a method 100 of extracting keywords according to an embodiment. The method 100 may be performed on a computer system (or a computer readable medium).

The method begins in step 110. In step 110, a corpus of documents is obtained or accessed. The corpus of documents may be obtained from a repository, which could be an electronic database. The electronic database may be an internal database, such as, an intranet of a company, or an external database, such as, Wikipedia. Also, the electronic database may be stored on a standalone personal computer, or spread across a number of computing machines, networked together, with a wired or wireless technology. For example, the electronic database may be hosted on a number of servers connected through a wide area network (WAN) or the internet.

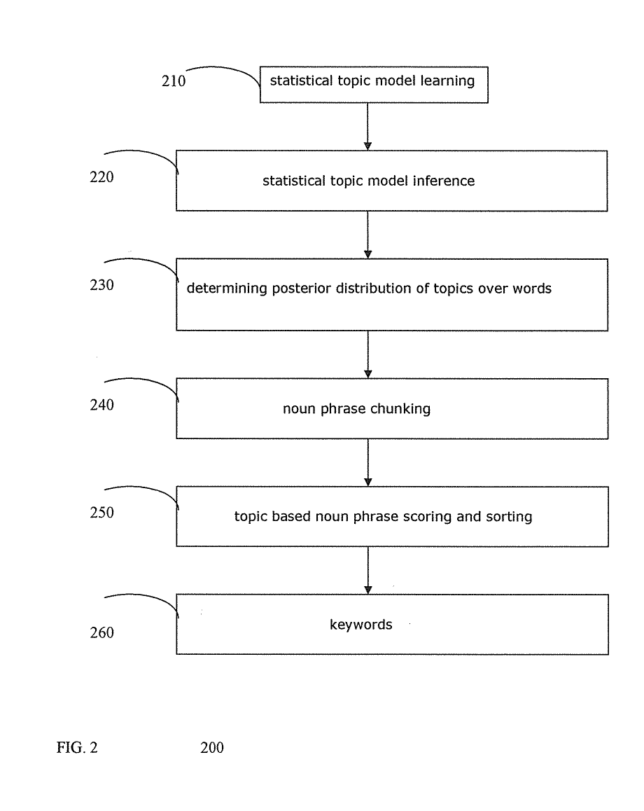

In step 120, a document is selected from the corpus of documents, and a set of words that appear as keywords in the document is determined. The method steps involved in the selection of a set of words that appear as keywords in the document are described in further detail with reference to FIG. 2 below. At the present step, it is suffice to say that any document present in the corpus of documents may be selected and a first set of words that appear as keywords in the document may be determined. Further, the present step may be repeated for any number of documents present in the corpus of documents.

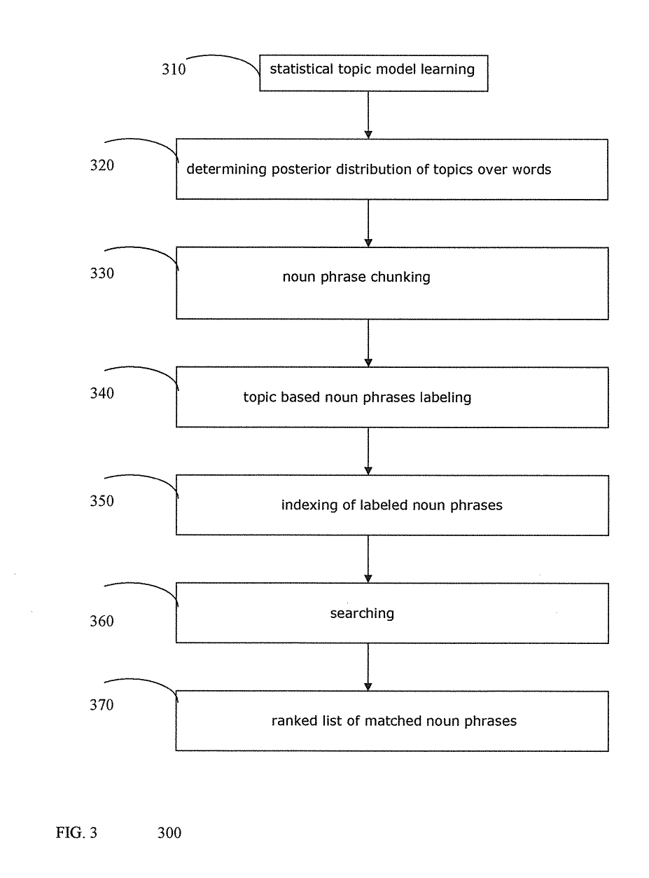

In step 130, a set of words that appear in the corpus of documents may be determined. Such set of words may not necessarily appear in the document selected in step 120. The method steps, involved in the determination of a second set of words that appear in the corpus of documents but may not necessarily appear as keywords in the document selected earlier, are described in further detail with reference to FIG. 3 below. The present step 130 is performed with regards to a corpus of documents.

In step 140, a final set of keywords for the document is determined. The step involves combining the first set of words, determined in step 120, with the second set of words, determined in step 120. Once the method steps outlined for step 120 and 130 are completed, a two set of keywords emerge that are used together to determine a final set of keywords for the document selected in step 120.

FIG. 2 shows a flowchart of a subroutine of the method of FIG. 1 according to an embodiment. The flowchart describes method step 120 in detail. The subroutine may be termed as in-document keyword extraction method. In an embodiment, the method involves following modules: learning of statistical topic modelling, inference of statistical topic modelling, noun phrase chunking, and topic-based noun phrase scoring. The main steps of the method are described as follows with notation used therein provided in Table 1 below.

TABLE 1
Notations

| | |
|---|---|
| D: a corpus of documents | d: a document |
| W: a vocabulary of words | w: a word, w ∈ W |
| Z: a set of topics | z: a topic, z ∈ Z |
| W_{d}: a set of words in document, W_{d}⊂W | |
| P(w\|z): probability of word w over topic z | P(z\|d): probability of topic 2 over document d |
| {P(w\|z)}_{w}: a multinomial distribution of words | {P(z\|d)}_{z}, a multinomial distribution of topics z |
| w∈ W over topic z, Σ_{w}P(w\|z) = 1 | ∈ Z over document d, Σ_{z}P(z\|d) = 1 |
| {P(w\|z)}_{w,z}: a set of multinomial distributions | {P(z\|d)}_{z,d}: a set of multinomial distributions of |
| of words W over topics Z | topics Z over documents D |
| P(z\|d,w): posterior probability of topic z over | {P(z\|d,w)}_{z}: a multinomial distribution of topic |
| word w in document d | z ∈ Z over word w in document d |
| {P(z\|d,w)}_{z,w}: a set of multinomial distributions | |
| of topics Z over words W_{d} in document d | |

In step 210, a topic model is learned for a corpus of documents D, by utilizing a statistic topic modelling method. Any statistic topic modelling method, such as, but not limited to, Probabilistic latent semantic analysis (PLSA) and Latent Dirichlet Allocation (LDA), represented by {P(w|z)}w,z, a set of multinomial distributions of words W over topics Z and optionally {P(z|d)}z,d, a set of multinomial distributions of topics Z over documents D, may be used. Optionally, a pre-processing step may be performed, which may comprise of stop word removal, word stemming, and transformation of the corpus into a word by document matrix. Step 210 may be executed just one time for a corpus of documents. Once a model has been learnt, it may be directly applied in the following steps.

In step 220, for a given document, a multinomial distribution of topics over the document is inferred, according to the statistical topic model, to determine main topics of the document. To illustrate, in an embodiment, for a document d, the distribution of topics Z over the document d, i.e. {P(z|d)}z, is inferred according to the learnt model (in step 210), which is used to determine the main topics T of the document by picking up the top k ones with the largest probabilities, i.e. T=argtopzP(z|d).

In step 230, posterior distributions of topics over words in the document is determined and used to assign topics to words in the document, resulting in a set of labeled words in triples. In an embodiment, the posterior distributions of topics over words in the document, i.e. {P(z|d,w)}z,w, are computed, which are used to assign topics to words by picking up the topic with the largest posterior probability for each word, i.e. z*d,w=argmaxz P(z|d,w), resulting in a set of labeled words in <w,z*,P(z*|d,w)> triples.

In step 240, a set of noun phrases are extracted from the same document by utilizing a noun phrase chunking method. The step may optionally include a post-processing step for filtering leading articles (e.g. “a”, “an”, “the”) and pronouns (e.g. “his”, “her”, “your” “that”, “those”, etc).

In step 250, the extracted noun phrases are scored, according to occurrence of words labeled with the main topics T, and sorted in a descending order.

The scoring methods may be varied. For example, in one embodiment, the posterior probabilities of words labelled with the main topics of the document may be summed up as the score of a noun phrase. In another embodiment, the length of a noun phrase may be considered as a scoring factor by preferring bigram or trigram noun phrases.

In step 260, the top m noun phrases with highest scores are provided as an output. The output is the first set of words that appear as keywords of the document.

FIG. 3 shows a flowchart of another subroutine of the method of FIG. 1 according to an embodiment. The flowchart describes method step 130 in detail. The subroutine may be termed as in-corpus keyword extraction method. The method extracts keywords that may appear in the corpus may not necessarily appear in a particular document. The steps of the method are described as follows.

In step 310, a statistical topic model with respect to a corpus of documents is learnt. Any statistic topic modelling method, such as, but not limited to, Probabilistic latent semantic analysis (PLSA) and Latent Dirichlet Allocation (LDA) may be utilized for learning the statistical topic model.

Once a statistical topic model has been determined, the following steps are performed for each document in the corpus.

In step 320, for each document in the corpus, posterior distributions of topics over words is determined and used to assign topics to the words, resulting in a set of labeled words in <word, topic, probability>triples;

In step 330, for each document in the corpus, noun phrases are extracted from the document by utilizing a noun phrase chunking method. Optionally, a post-processing step of removing the articles and pronouns as described earlier may be performed, resulting in a set of noun phrases.

In step 340, each extracted noun phrase is labeled by associating each word with a topic and a weight according to the triples. This results in a sequence of triples. An output of labeled noun phrases is provided into a repository. The repository may be an electronic database.

In step 350, labeled noun phrases are read out from the repository and indexed with the help of an index engine. While indexing, the index engine may organize the sequence of triples in a way that supports the word-based search and the topic-based search, and supports the search result ranking by considering the probability as a scoring factor (step 360). Apache Lucene index engine, among others, may be customised to perform this task.

In step 370, for main topics of the document, a string query is composed. This may be done by concatenating the main topics of the document in a Boolean logic and then submitting the string query to the index engine. This results in a ranked list of matched noun phrases. The top n noun phrases are returned as keywords for the document. These are the second set of words that appear in the corpus of documents, but may not necessarily appear in the document.

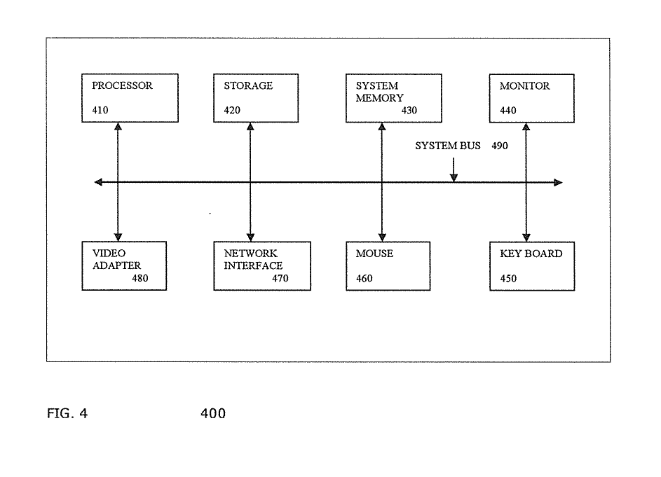

FIG. 4. shows a block diagram of a computer system 400 upon which an embodiment may be implemented. The computer system 400 includes a processor 410, a storage medium 420, a system memory 430, a monitor 440, a keyboard 450, a mouse 460, a network interface 420 and a video adapter 480. These components are coupled together through a system bus 490.

The storage medium 420 (such as a hard disk) stores a number of programs including an operating system, application programs and other program modules. A user may enter commands and information into the computer system 400 through input devices, such as a keyboard 450, a touch pad (not shown) and a mouse 460. The monitor 440 is used to display textual and graphical information.

An operating system runs on processor 410 and is used to coordinate and provide control of various components within personal computer system 400 in FIG. 4. Further, a computer program may be used on the computer system 400 to implement the various embodiments described above.

It would be appreciated that the hardware components depicted in FIG. 4 are for the purpose of illustration only and the actual components may vary depending on the computing device deployed for implementation of the present invention.

Further, the computer system 400 may be, for example, a desktop computer, a server computer, a laptop computer, or a wireless device such as a mobile phone, a personal digital assistant (PDA), a hand-held computer, etc.

The embodiment described provides an effective way of extracting keywords from a document by utilizing the noun phrase chunking technology to extract high-quality keyword candidates, and the statistic topic modelling technology to analyze the latent topics of text documents. The embodiment ranks the keyword candidates by considering the topic relevance between the candidate and the document as a scoring factor. By combining the in-document method and the in-corpus method, it generates a set of in-document keywords and a set of out-of-document keywords.

It will be appreciated that the embodiments within the scope of the present invention may be implemented in the form of a computer program product including computer-executable instructions, such as program code, which may be run on any suitable computing environment in conjunction with a suitable operating system, such as, Microsoft Windows, Linux or UNIX operating system. Embodiments within the scope of the present invention may also include program products comprising computer-readable media for carrying or having computer-executable instructions or data structures stored thereon. Such computer-readable media can be any available media that can be accessed by a general purpose or special purpose computer. By way of example, such computer-readable media can comprise RAM, ROM, EPROM, EEPROM, CD-ROM, magnetic disk storage or other storage devices, or any other medium which can be used to carry or store desired program code in the form of computer-executable instructions and which can be accessed by a general purpose or special purpose computer.

It should be noted that the above-described embodiment of the present invention is for the purpose of illustration only. Although the invention has been described in conjunction with a specific embodiment thereof, those skilled in the art will appreciate that numerous modifications are possible without materially departing from the teachings and advantages of the subject matter described herein. Other substitutions, modifications and changes may be made without departing from the spirit of the present invention.

1. A computer-implemented method of extracting keywords, comprising:
obtaining a corpus of documents;
determining a first set of words that appear as keywords in a document present in the corpus of documents;
determining a second set of words that appear in the corpus of documents but not necessarily appear as keywords in the document; and
determining a final set of keywords for the document by combining the first set of words with the second set of words.

2. A method according to claim 1, wherein the step of determining a first set of words that appear as keywords in a document, comprises:
learning a statistical topic model in respect of the corpus of documents;
inferencing, with respect to the document, a multinomial distribution of topics over the document according to the statistical topic model, to determine main topics of the document;
determining of posterior distributions topics over words in the document to assign topics to words in the document, resulting in a set of labeled words in triples;
extracting noun phrases from the document by utilizing a noun phrase chunking method;
scoring the noun phrases according to occurrence of words labeled with the main topics;
sorting the noun phrases in a descending order; and
outputting the top noun phrases with highest scores as the first set of words that appear as keywords of the document.

3. A method according to claim 2, further comprising, prior to the learning step, a preprocessing step, comprising:
removing of stop words;
stemming of words; and
transforming of the corpus of the documents into a word by a document matrix.

4. A method according to claim 2, wherein the statistical topic model is represented by a set of multinomial distributions of words over topics, and optionally a set of multinomial distributions of topics over the corpus of documents.

5. A method according to claim 2, wherein the statistical topic model is learned by Probabilistic latent semantic analysis (PLSA) or Latent Dirichlet Allocation (LDA) statistic topic modeling method.

6. A method according to claim 2, wherein determining the main topics of the document include selecting topics with largest probabilities.

7. A method according to claim 2, wherein the set of labeled words in triples is represented as <word, topic, probability>.

8. A method according to claim 2, further comprising, prior to the scoring step, a pre-processing step for filtering lead articles.

9. A method according to claim 1, wherein the step of determining a second set of words that appear in the corpus of documents, comprises:
learning a statistical topic model in respect of the corpus of documents;
determining, for each document in the corpus, posterior distributions of topics over words to assign topics to the words, resulting in a set of labeled words in triples;
extracting, for each document in the corpus, noun phrases from the document by utilizing a noun phrase chunking method;
labeling each extracted noun phrase by associating each word with a topic and a weight according to the triples; and
outputting the labeled noun phrases into a repository.

10. A method according to claim 9, further comprising reading out the labeled noun phrases from the repository and indexing the noun phrases with an index engine.

11. A method according to claim 10, further comprising:
composing, for main topics of the document, a string query by concatenating the main topics of the document in a Boolean logic; and
submitting the string query to the index engine, resulting in a ranked list of matched noun phrases, wherein top noun phrases are the second set of words that appear in the corpus of documents.

12. A method according to claim 1, wherein the corpus of documents is obtained from a repository.

13. A system, comprising:
a processor; and
a memory coupled to the processor, wherein the memory includes instructions for:
obtaining a corpus of documents;
determining a first set of words that appear as keywords in a document present in the corpus of documents;
determining a second set of words that appear in the corpus of documents but not necessarily appear as keywords in the document; and
determining a final set of keywords for the document by combining the first set of words with the second set of words.

14. A computer program comprising computer program means adapted to perform all of the steps of claim 1 when said program is run on a computer.

15. A computer program according to claim 14 embodied on a computer readable medium.
